(19) United States
(12) Patent Application Publication
(10) Pub. No.: US 2002/0007319 A1
(43) Pub. Date: Jan. 17, 2002

(54) Method of tracing a shopping path of a consumer

(76) Inventor: Tzu-Yun Yu, Pan-Chiao City (TW)

Correspondence Address: BACON & THOMAS, PLLC, 4th Floor, 625 Slaters Lane, Alexandria, VA, 22314-1176, US

(21) Appl. No.: 09/736,257

(22) Filed: Dec. 15, 2000

(30) Foreign Application Priority Data
Jul. 17, 2000 (TW) 89114278

(51) Int. Cl. G06F 17/60

(52) U.S. Cl. 705/26

(57) ABSTRACT

The present invention provides a method of tracing a shopping path of a consumer. The method enables the consumer to directly return back to any transaction-occurred shopping web page. The method involves: establishing a shopping path record to record all of the uniform resource locators (URLs) of transaction-occurred shopping web pages of the consumer; providing a database for storing the shopping path record of the consumer; displaying a shopping path record list to enable the consumer to choose a recorded item in the shopping web page; receiving a request from the consumer for returning back to one transaction-occurred recorded shopping web page; and linking to the chosen recorded shopping web page.

### BACKGROUND OF THE INVENTION

1. Field of the Invention

The present invention relates to a method of network shopping, and, more particularly, to method of tracing a shopping path of a consumer.

2. Description of the Related Art

The Internet has provided consumers with a new medium for electronic commerce. Currently, numerous consumers prefer to shop on the Internet. Most of shopping websites provide many different kinds of items for consumers. The consumer connects to the shopping websites via a network communication device with browsing functionality, such as a personal computer, notebook, mobile phone, etc.

Traditionally, a shopping website categorizes the items offered to present them to the consumer. It is possible that the consumer browses over 10 web pages on the same shopping website but only orders two items. When the consumer finishes shopping, the shopping website shows a shopping list which includes all the items chosen by the consumer. However, the browsers of present-day browsing programs only have a “Return to last page” function. Therefore, when the consumer wants to know the contents of an ordered item again, he has to keep returning back to previous web pages until reaching the web page containing the ordered item. Furthermore, when the consumer first orders an item, but later decides to cancel the order, the prior art shopping website will not display this related information to the consumer at the end of the shopping session. So the consumer will not have chance to reconsider the item again.

### SUMMARY OF THE INVENTION

The object of the present invention is to provide a method and computer-implemented program for tracing a shopping path of a consumer, thus enabling the consumer to directly return back to any transaction-occurred shopping web page. When the consumer chooses an ordered item in a recorded shopping web page, the shopping website will link to the shopping web page and display the contents.

Another object of the present invention is to provide an order-cancelled item list to the consumer, so the consumer can retrieve information about cancelled items and return back to the shopping web page containing the order-cancelled item.

To achieve these objectives, the method of the present invention includes establishing a shopping path record to record all of the uniform resource locators (URLs) of transaction-occurred shopping web pages of the consumer; providing a database for storing the shopping path record of the consumer; displaying a shopping path record list to enable the consumer to choose a recorded item in the shopping web page; receiving a request from the consumer for returning back to a transaction-occurred recorded shopping web page; and linking to the recorded shopping web page. The consumer can return to any one of the ordered items in the recorded shopping web pages by selecting the shopping path record list to modify a transaction.

Other objects, advantages, and novel features of the invention will become more apparent from the following detailed description when taken in conjunction with the accompanying drawings.

### BRIEF DESCRIPTION OF THE DRAWINGS

FIG. 1 is a work environment schematic drawing of the method of the present invention.

FIG. 2 is a flowchart of the method of the present invention.

FIG. 3 is a schematic drawing of a shopping path record list of the present invention.

FIG. 4 is a schematic drawing of another embodiment of the present invention.

### DETAILED DESCRIPTION OF THE PREFERRED EMBODIMENT

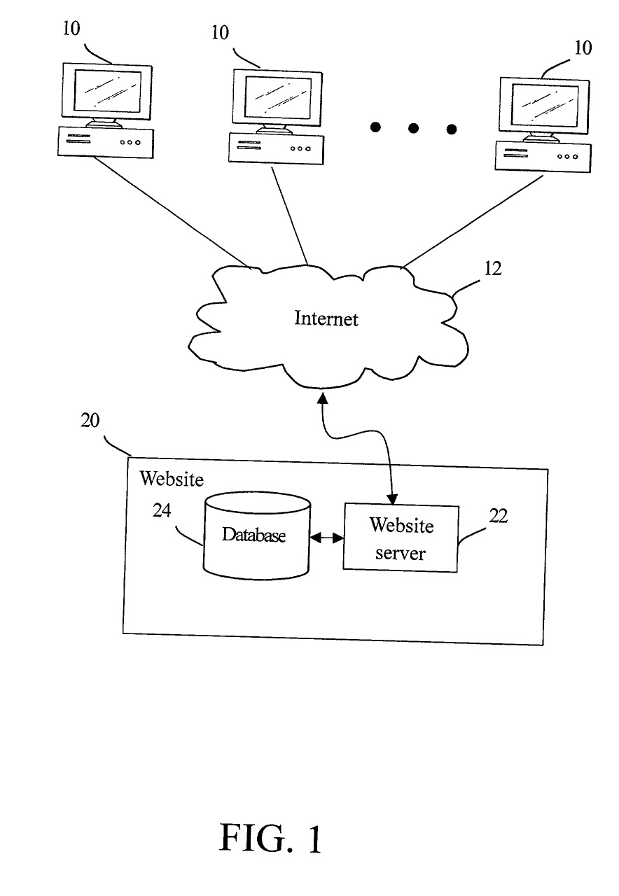

Please refer to FIG. 1. FIG. 1 is a work environment schematic drawing of the method of the present invention. A plurality of consumers 10 use a computer to connect to a shopping website 20 via a network 12. The shopping website 20 has a web server 22 and a database 24. The computer could be any kind of network communication device enabled with browsing functionality, such as a personal computer, notebook, mobile phone, etc. In this manner, the potential consumers 10 can shop on-line at the shopping website 20.

In order to offer various choices to the consumer 10, the shopping website 20 provides a plurality of different items, so the consumer 10 can purchase several different items in a session. However, these items may be arranged on different web pages. The database 24 of the shopping website 20 will record a shopping path of the consumer 10.

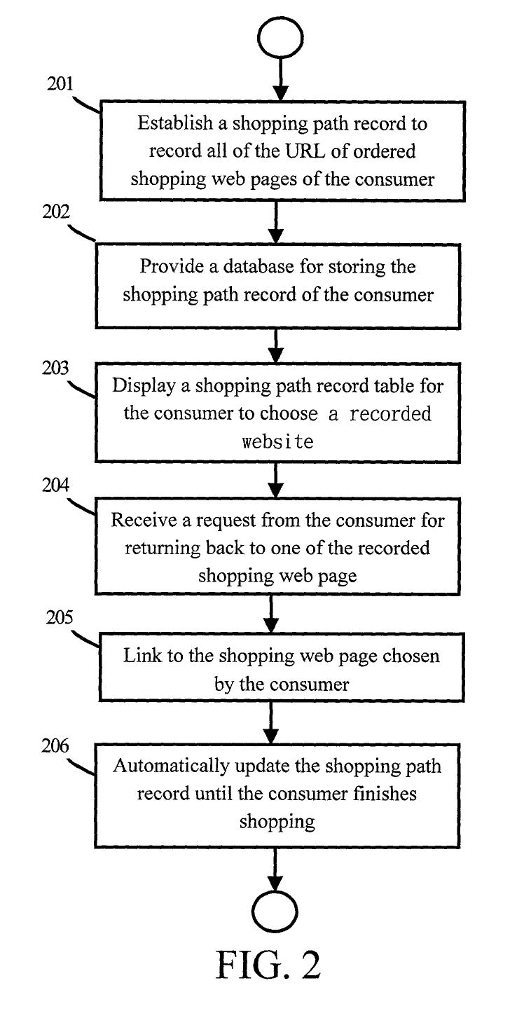

Please refer to FIG. 2. FIG. 2 is a flowchart of the method of the present invention. After the consumer 10 logs into the shopping website 20, the consumer 10 can start to purchase the items on the shopping website 20. In the following, a “transaction-occurred” shopping web page is a shopping web page at which the consumer 10 has ordered an item, or cancelled an order. The following steps explain the method of tracing a shopping path of the consumer 10:

Step 201: establishing a shopping path record to record all of the uniform resource locators (URLs) of transaction-occurred shopping web pages of the consumer 10;

Step 202: providing a database 24 for storing the shopping path record of the consumer 10;

Step 203: displaying a shopping path record list 26 to enable the consumer 10 to choose a recorded item in the associated shopping web page;

Step 204: receiving a request from the consumer 10 for returning back to one transaction-occurred recorded shopping web page;

Step 205: linking to the chosen recorded shopping web page; and

Step 206: automatically updating the shopping path record until the consumer 10 finishes shopping.

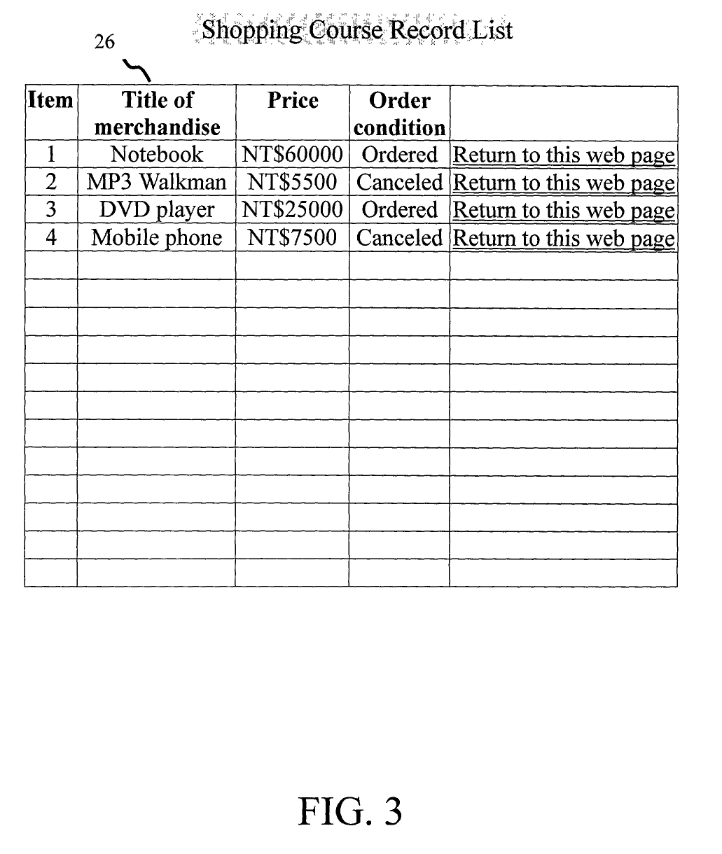

Please refer to FIG. 3. FIG. 3 is a schematic drawing of a shopping path record list 26 of the present invention. The shopping website 20 presents the shopping path tracing functionality to the consumer 10 via a pop-up window function or by displaying a virtual functional button on each web page. In steps 203 and 204, the consumer 10 chooses the recorded items in the shopping path record list 26 to return back to any one of transaction-occurred recorded shopping web pages to modify the original purchase. The URLs recorded in the web page shopping path record includes the URLs of ordered shopping web pages and the URLs of order-cancelled shopping web pages. Additionally, the shopping path record list 26 further includes related item information, such as the title of the item, a description of item, the purchase price and the order status. As shown in FIG. 3, when the consumer 10 chooses a recorded item in the shopping path record list 26, the shopping website 20 will immediately link to the web page that contains this recorded item and display the appropriate web page.

When the consumer 10 enters into the shopping website 20, the web server 22 of the shopping website 20 establishes a specific text file for the consumer 10, and stores this text file under a subdirectory of the browsing program directory, which is usually called a “cookie”. This text file provides the storage and the transmission of extra information between the web server 22 of the shopping website 20 and the browsing program.

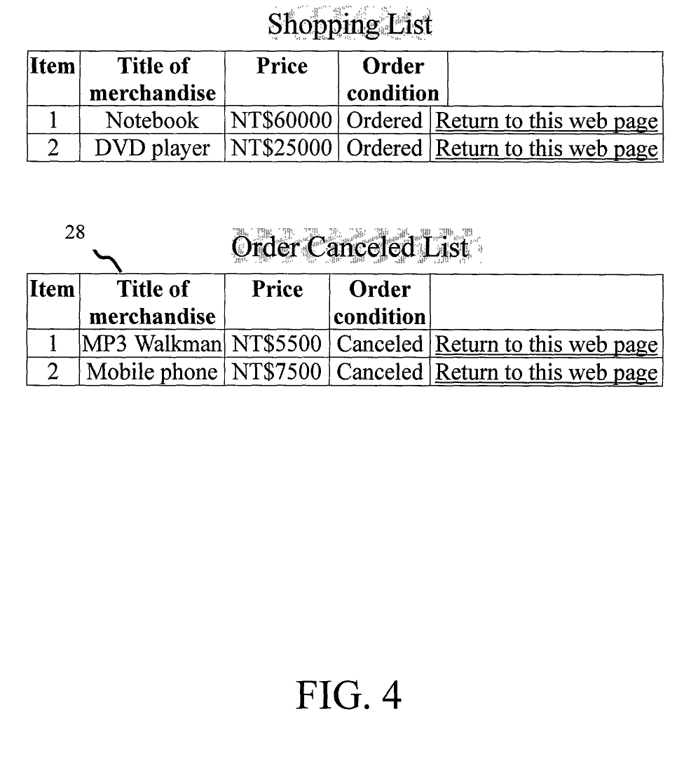

Please refer to FIG. 4. FIG. 4 is a schematic drawing of another embodiment of the present invention. In the prior art technology, when the consumer 10 finishes shopping, the typical shopping website displays a shopping list 27 before the consumer 10 pays the bill, so the consumer 10 can verify the transaction. In another embodiment of the present invention, in addition to the shopping list 27, the shopping website 20 also displays an order-cancelled item list 28, and provides a “return to this web page” virtual button. The consumer 10 can thus not only check all of the transaction-occurred (including the order-cancelled) items, but can also select the recorded shopping web page to return back to it.

The method of the present invention should be executed by a computer program. The method of the present invention can be coded as a computer program on a computer readable medium, such as a hard disk, a floppy disk, an optical disk and other computer readable mediums. The computer usable medium has computer readable program code means embedded in the medium for tracing the shopping path of a consumer 10. The computer program product comprises: a first program code for causing the computer to establish a shopping path record to record all of the uniform resource locators (URLs) of transaction-occurred shopping web pages of the consumer 10; a second program code for causing the computer to provide a database 24 for storing the shopping path record of the consumer 10; a third program code for causing the computer to display a shopping path record list 26 to enable the consumer 10 to choose an ordered item in the recorded shopping web page; a fourth program code for causing the computer to receive a request from the consumer 10 for returning back to the transaction-occurred recorded shopping web page; a fifth program code for causing the computer to link to the recorded shopping web page; and a sixth program code for causing the computer to automatically update the shopping path record until the consumer 10 finishes shopping.

Summarizing the above-mentioned disclosure, the method and the computer program product of the present invention enable the consumer to directly return back to any transaction-occurred shopping web page. Therefore, the consumer can find the shopping web page again, instead of using the standard browsing functions of the browsing program to look for the ordered item page by page. Furthermore, the present invention further provides an order-cancelled item list, so the consumer has a chance to reconsider cancelled items again. Therefore, the shopping website of the present invention can offer more shopping information to consumers, so more consumers will be attracted by the service of the website and encourage more sales.

Although the present invention has been explained in relation to its preferred embodiment, it is to be understood that many other possible modifications and variations can be made without departing from the spirit and scope of the invention as hereinafter claimed.

What is claimed is:

1. A method of tracing a shopping path of a consumer, the method enabling the consumer to directly return back to any transaction-occurred shopping web page, the method comprising:
establishing a shopping path record to record all of the uniform resource locators (URLs) of transaction-occurred shopping web pages of the consumer;
providing a database for storing the shopping path record of the consumer;
displaying a shopping path record list to enable the consumer to choose a recorded item in the shopping web page;
receiving a request from the consumer for returning back to one transaction-occurred recorded shopping web page; and
linking to the chosen recorded shopping web page; wherein the consumer can return to any one of the ordered items in the recorded shopping web pages by selecting the shopping path record list to modify a transaction.

2. The method of tracing a shopping path of claim 1, wherein the URLs recorded in the shopping path record includes the URL of an ordered shopping web page and or URL of an order-cancelled shopping web page.

3. The method of tracing a shopping path of claim 1, wherein the shopping path record list further includes related item information.

4. The method of tracing a shopping path of claim 3, wherein the related item information includes: a title of an item, a description of the item, a purchase price of the item or an order status.

5. The method of tracing a shopping path of claim 1, wherein the method further comprises automatically updating the shopping path record until the consumer finishes shopping.

6. A computer program product for tracing a shopping path of a consumer, the computer program product comprising:
a computer usable medium having computer readable program code means embodied in the medium for enabling the consumer to directly return back to any transaction-occurred shopping web page, the computer program product having:
a first program code for causing the computer to establish a shopping path record to record all of the uniform resource locators (URLs) of transaction-occurred shopping web pages of the consumer;
a second program code for causing the computer to provide a database for storing the shopping path record of the consumer;
a third program code for causing the computer to display a shopping path record list to enable the consumer to choose an ordered item in the recorded shopping web page;
a fourth program code for causing the computer to receive a request from the consumer for returning back to a transaction-occurred recorded shopping web page; and
a fifth program code for causing the computer to link to the recorded shopping web page; wherein the consumer can return to any one of the ordered shopping web pages by selecting the shopping path record list to modify a transaction.

7. The computer program product of tracing a shopping path of claim 6, wherein the shopping path record of the first program code includes the URL of the ordered shopping web page or the URL of a ordered-cancelled shopping web page.

8. The computer program product of tracing a shopping path of claim 6, wherein the shopping path record of the third program code further includes related item information.

9. The computer program product of tracing a shopping path of claim 8, wherein the related item information includes: a title of an item, a description of the item, a purchase price of the item or order status.

10. The computer program product of a tracing a shopping path of claim 6, wherein the computer program product further comprises a sixth program code for causing the computer to automatically update the shopping path record until the consumer finishes shopping.

11. The computer program product of tracing a shopping path of claim 6, wherein the third program code contains a pop-up window function program.
